(19) United States
(12) Patent Application Publication
(10) Pub. No.: US 2017/0202731 A1
(43) Pub. Date: Jul. 20, 2017

(54) DEVICES AND METHODS FOR FACILITATING FEMALE SEXUAL AROUSAL, INTEREST AND SATISFACTION

(71) Applicant: Nuelle, Inc., Mountain View, CA (US)

(72) Inventors: Eric A. Goldfarb, Belmont, CA (US); Joshua Makower, Los Altos Hills, CA (US); Earl A. Bright, Los Altos, CA (US)

(21) Appl. No.: 15/402,882

(22) Filed: Jan. 10, 2017

Related U.S. Application Data
(60) Provisional application No. 62/278,438, filed on Jan. 14, 2016.

(51) Int. Cl. A61H 19/00

(52) U.S. Cl. CPC A61H 19/34; A61H 2201/1409; A61H 2201/165

(57) ABSTRACT

A female sexual wellness device configured to provide stimulation frequencies targeting a specific nerve response of clitoral tissue. In one embodiment, the device can alternatively include a motor that creates an oscillatory air pressure wave.

### FIELD OF THE DISCLOSURE

The disclosure relates generally to devices and methods for promoting female sexual wellness and, more particularly, to devices and methods for promoting female sexual arousal, interest and satisfaction.

### BACKGROUND OF THE DISCLOSURE

Clitoral vascular engorgement plays an important role in female sexual interest or desire, arousal and satisfaction. Sexual arousal results in smooth muscle relaxation and arterial vasodilation within the clitoris. The resultant increase in blood flow leads to tumescence of the glans clitoris and increased sexual arousal.

Female sexual wellness and satisfaction can be addressed by embodiments of the present disclosure.

### SUMMARY OF THE DISCLOSURE

Briefly and in general terms, the present disclosure is directed towards a female sexual interest device. In one approach, the device includes one or more stimulation sources that are configured to provide frequencies that match specific nerve responses of target tissue. In another approach, the device can alternatively or additionally include a secondary actuator that creates a secondary oscillation pressure wave above a suction set point.

These and other features of the disclosure will become apparent to those persons skilled in the art upon reading the details of the systems and methods as more fully described below.

### BRIEF DESCRIPTION OF THE DRAWINGS

FIGS. 1A through 1D illustrate various views of a device according to an embodiment of the disclosure.

FIGS. 2A and 2B illustrate views of a device and a controller according to an embodiment of the disclosure.

FIG. 3A illustrates a cross-sectional view of a device according to an alternative embodiment of the disclosure.

FIG. 3A′ illustrates a cross-sectional view of a device according to another alternative embodiment of the disclosure.

FIG. 3A″ illustrates bottom view of the device shown in FIG. 3A′.

FIG. 3B is a graphical representation of the performance of the device shown in FIG. 3A.

FIGS. 4A through 4E illustrate use of various embodiments of the disclosure.

FIGS. 5A through 5C illustrate user interfaces for a smartphone-type controller.

### DETAILED DESCRIPTION OF THE DISCLOSURE

Embodiments of the present disclosure described herein, including the figures and examples, are useful for promoting female sexual wellness and function.

Before the present devices and methods are described, it is to be understood that this disclosure is not limited to particular embodiments described. It is also to be understood that the terminology used herein is for the purpose of describing particular embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Although any methods and materials similar or equivalent to those described herein can be used in the practice or testing of the present disclosure, the preferred methods and materials are now described. All publications mentioned herein are incorporated herein by reference to disclose and describe the methods and/or materials in connection with which the publications are cited.

Short summaries of certain terms are presented in the description of the disclosure. Each term is further explained and exemplified throughout the description, figures, and examples. Any interpretation of the terms in this description should take into account the full description, figures, and examples presented herein.

The singular terms “a,” “an,” and “the” include plural referents unless the context clearly dictates otherwise. Thus, for example, reference to an object can include multiple objects unless the context clearly dictates otherwise. Similarly, references to multiple objects can include a single object unless the context clearly dictates otherwise.

The terms “substantially,” “substantial,” and the like refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

The term “about” refers to a value, amount, or degree that is approximate or near the reference value. The extent of variation from the reference value encompassed by the term “about” is that which is typical for the tolerance levels or measurement conditions.

The term “stimulator” refers to elements that provide stimulation using mechanical motion (such as vibration), sonic stimulation, air pressure stimulation, electrical stimulation, temperature, or other sensory stimulation.

All recited connections may be direct connections and/or indirect operative connections through intermediary structure.

A set of elements includes one or more elements.

Unless otherwise stated, performing a comparison between two elements encompasses performing a direct comparison to determine whether one element is larger (or larger than equal to) the other, as well as an indirect comparison, for example by comparing a ratio or a difference of the two elements to a threshold.

Unless otherwise required, any described method steps need not be necessarily performed in a particular illustrated order. A first element, for example data, derived from a second element encompasses a first element equal to the second element, as well as a first element generated by processing the second element and optionally other data. Making a determination or decision according to a parameter encompasses making the determination or decision according to the parameter and optionally according to other data. Unless otherwise specified, an indicator of some quantity/data may be the quantity/data itself, or an indicator different from the quantity/data itself. Computer readable media includes non-transitory storage media such as magnetic, optic, and semiconductor media, as well as communications links such as conductive cables and fiber optic links. Semiconductor media includes magnetic and other hard drives, optical drives and disks, flash memory and dynamic random access memory (DRAM). According to some embodiments, the present disclosure includes computer systems, mobile communication devices and/or any other suitable computing device programmed to perform the methods described herein, for example either through firmware, software or both, as well as in some instances computer-readable media encoding instructions to perform the methods described herein.

We have discovered that engorgement created by suction and stimulation with a stimulator together are a powerful combination such that engorgement creates a more suitable mechanical back-board for the pacinian corpuscles to be stimulated and that applying both simultaneously should produce more profound effects than either applied alone. In both sexes, engorgement of the sexual organs is the key physiological target in that engorgement is fundamental to achieve a sexually satisfying event. Embodiments described herein provide methods and devices for engorging sexual organs to better propagate stimulation energy. It has also been recognized that generating frequencies that match clitoral nerve tissues can enhance sexual wellness and satisfaction, as can the use of air pressure to generate oscillating target or desired frequencies.

Certain prior art stimulation devices, such as vibrators, provide relatively diffuse stimuli. That is, the vibrating motion supplied by a vibrator is applied relatively evenly over the clitoris and surrounding tissue. In certain vibrating devices that are capable of delivering vibration over a more tightly focused area, the frequency and magnitude of the vibration may still present a relatively diffuse vibratory motion to clitoral tissue. Additionally, much of the vibration of prior art vibrators is lost in vibrating the handle, housing and the user's hand or other portion of their body.

Advantageously, certain embodiments described herein are capable of providing complex patterns of stimulation and/or suction. Such complex waveforms can provide a comparatively organic stimulation experience as compared to prior art mechanical stimulation devices. For some users, the variable suction patterns and algorithmic waveforms of certain embodiments can provide engorgement and stimulation such that arousal and/or satisfaction is achieved without the use of vibration.

Certain embodiments of the present disclosure are related to systems, methods and computer-readable media for promoting female sexual wellness; for managing an attachment of a suction device to a user's tissue, in particular using an auto-attachment operating mode; and for managing an operation of a suction pump of such a device according to indicators of leaks and/or quality of the seal established between the device and user tissue.

Certain embodiments of devices disclosed herein use suction to draw tissue into contact with a stimulator. Certain devices remain in contact with tissue in a hands-free manner by virtue of the suction applied to the tissue. Yet another benefit of isolating stimulation in devices is that the airtight seal between the device and tissue is not substantially disrupted by the stimulation.

The compact size of devices disclosed herein makes them capable of being discreetly worn and capable of being carried in a purse. Yet, devices disclosed herein are sized and configured to be accessible and controllable while being worn. Devices disclosed herein may be usable prior to and during intercourse or as a program for recruitment of blood flow and nerve sensitization of tissue. Devices disclosed herein may be adjustable and customizable and provide selectable, variable suction and stimulation properties. Devices disclosed herein may be capable of being controlled remotely, such as by a smartphone or remote control. Devices discloses herein may be capable of promoting and/or sustaining female sexual arousal.

Advantageously, in one embodiment devices disclosed herein use relatively low power motors to produce focused, spatially-differentiated vibration. In another embodiment, alternating air pressure is used to produce clitoral stiulation.

In certain embodiments, proper placement can be achieved by activating one or more motors to a detectable level of vibration to allow the user to center the stimulatory effect about the clitoris. By pre-activating the motors during placement, the user can customize the fit and determine the most effective location for vibrational simulation and/or suction stimulation.

Specific aspects of the device features may include some or all of the following: (i) the user is able to set suction to the level that is comfortable to them; (ii) the user is able to detach a suction tube from the device without losing vacuum pressure that leads to device detachment; (iii) the user is able to control stimulation function by means of wireless remote control; (iv) the user interface is via iOS, Android, or other mobile operating system application on a Bluetooth enabled device or via an RF or Bluetooth remote controller; (v) the user is able to control stimulation parameters such as pattern transition speed and amplitude; (vi) power is provided via an internal rechargeable battery; (vii) the user is able to control/direct stimulation focus through pointing with finger on a wireless enabled device; (viii) the user is able to control degree of stimulation overlap from two or more stimulators; (ix) the stimulator is optimized for organic feel; (x) the device is enabled with basic rotational stimulation patterns; (xi) the device withstands an external force applied to the external shell (over the attachment area) by the user; (xii) the shell withstands sufficient vacuum cycles without loss of integrity; (xiii) the user is able to customize the stimulation pattern including direction, motor selection, looping, and save/recall the customized pattern; and (xiv) the user is able to customize the stimulation pattern and save/recall the customized pattern. Studies have shown that different areas of the female brain are activated when the clitoris is self-stimulated than when the clitoris is stimulated by a partner and that often times a female can achieve orgasm easier through self-stimulation than when stimulated by a partner. With the certain embodiments of the devices described herein, the female can record the stimulation pattern that allows her to achieve orgasm through self-stimulation and store it in the devices memory. Subsequently, the device can be used during intercourse to play the saved pattern such that the female can achieve orgasm as if she were self-stimulating.

Preferred attributes of certain embodiments include: (i) user adjustable suction for fixation and blood flow recruitment; (ii) user adjustable stimulation for blood flow recruitment and nerve stimulation; (iii) spatially differentiated stimulation via macro-motion or isolation & control of multiple stimulation sources; (iv) tether-less and wearable before or during intercourse; and (v) customizable & reusable.

Certain embodiments of the device include onboard circuitry, power, pump, or other electronic features. For example, the device includes an antenna for interacting with the remote controller, such as an RF antenna. The device includes a battery.

Certain embodiments of the device are controlled by a remote drive connected via drive cable to stimulatory and/or suction elements inside the wearable part of the device.

Certain embodiments of the device provide variable suction. In such embodiments, the user may rapidly and easily adjust the suction levels. Further, in certain embodiments the variable suction is programmable such that the amount of suction applied by the device can vary according to a pattern. In some instances, the suction pattern is complementary to the stimulation and/or macroscopic motion patterns. The device controller includes a means for controlling the suction patterns, pre-loaded suctions patterns, user-configurable suctions patterns, or combinations thereof. The device controller enables the user to selected pre-loaded combinations of a suction pattern, a stimulation pattern, and/or a macroscopic motion pattern and also enables the user to design and select customized combinations.

The control systems, software, firmware, algorithms, and system architecture disclosed herein can be used in connection with devices disclosed in U.S. patent application Ser. No. 13/798,085, filed Mar. 13, 2013; Ser. No. 14/467,018, filed Aug. 24, 2014; and Ser. No. 14/759,707, filed Jul. 8, 2015, as well as U.S. provisional application No. 62/152,597, filed Apr. 24, 2015, the contents of which are hereby incorporated herein, in their entirety, by reference.

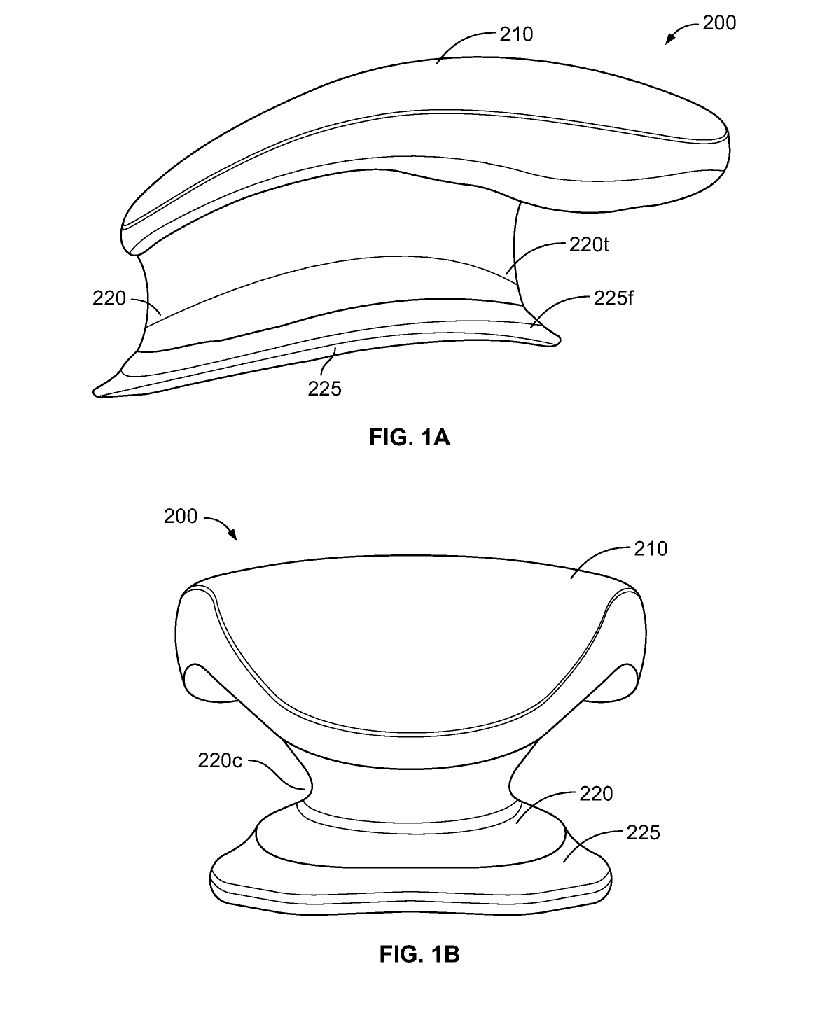

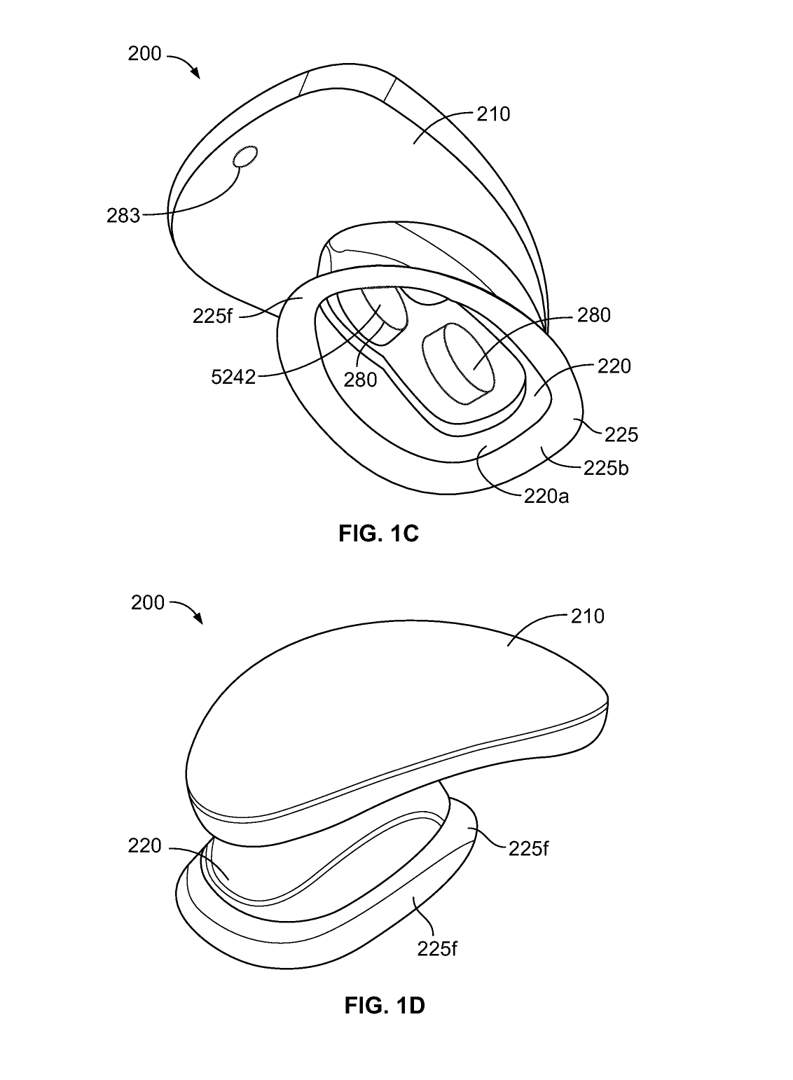

FIGS. 1A, 1B, 1C, and 1D illustrate different views of an embodiment of a female sexual wellness device or apparatus of the disclosure, also sometimes referred to herein as a sexual arousal device or apparatus, female arousal device or apparatus, or device or apparatus. Device 200 includes device body 210, which can house controller circuitry, for example controller block or circuit, and suction chamber 220. Chamber 220 may be referred to by other names, such as a chamber, vacuum chamber or tissue chamber. The controller circuitry can be accessed using an interface mounted on device body 210 and/or via a remote controller. The remote controller can be physically tethered to device body 210 or it can be wirelessly connected. Suction body 220 includes sealing and flange 225, which is adapted to provide a substantially airtight seal against tissue. In one embodiment, flange 225 is substantially rigid so as to retain its shape during use, but can additionally be elastic so as to facilitate engagement with the user and enable a suction or fluid-tight fit between flange 225 and the user. In one embodiment, at least flange 225 is made from a suitable elastic material such as silicone. The various views of FIGS. 1A, 1B, 1C, and 1D illustrate certain features of the shape and form of device 200 which promote comfortable, discreet, and secure attachment of device 200. For example, device 200 is sized such that the attachment area, which can be defined by the area where sealing flange 225 meets opening 220a of suction chamber 220, fits between the labia majora inferior to the clitoris and device body 210 may exit the labia majora superior to the clitoris. Further, the taper of the outer upper section of suction chamber 220 facilitates comfortable, discreet, and secure fit. The curve of device body 210 can help device 200 conform to the user and allow discreet placement inside garments. In one embodiment, one or more suitable feedback indicators such as light emitting diodes (LEDs) 283 can be provided on the inside of the device body 21, for example on the underside of the device body 21. The feedback indicator(s) 283 can be utilized for any variety of purposes, such as providing feedback to the user during the placement or operation of the device 200 or both. One or more temperature sensors 5242, which can be thermistors, can be provided in device 200 for measuring the temperature of the active stimulators in the vicinity of where the stimulators engage the tissue of the user. In one embodiment, at least one temperature sensor 5242 is provided for each of the plurality of three active stimulators.

In one embodiment, the front section 225f of sealing flange 225 is placed superior to the clitoris and tucked under the anterior commissure of the labia majora. In one embodiment, the front section 225f of the sealing flange has contour to sealingly engage the user under the anterior commissure of the labia majora. In that position, the labia majora inferior to the anterior commissure can snugly engage the tapered section 220t of suction chamber 220 such that substantially the entire front and lateral portions of the sealing flange 225 are tucked under the labia majora. Advantageously, the tapered section 220t of suction chamber 220 allows the labia majora to comfortably and sealingly engage a comparatively narrower section of the device while vaginal tissue superior to the vaginal orifice can sealingly engage the comparatively wider sealing flange 225. In one embodiment, flange 225 is sized and shaped to fit over a clitoris of a user and suction chamber is larger than the clitoris of the user. In one embodiment, lower or bottom surface 225b of the flange 225 can have a shape approximating the shape of the tissue surrounding the clitoris, for example the tissue surrounding the clitoris interior of the labia majora, so as to promote or facilitate a fluid-tight, sealable or suction fit between the flange 225 and such tissue.

Proper placement of device 200 can be easily and repeatably achieved by following a few steps. For example, when a user first attempts to place the device, they may benefit from the use of a mirror such that the user's head and shoulders are propped up and they can use the mirror to observe themselves placing the device. The user can open their outer labia so that they can see their inner labia and the hooded glans of the clitoris. Users can identify a groove within their outer labia that runs along the inner labia at the bottom and the hooded clitoris at the top. Device 200 can be effective when the sealing flange 225 is centered over the clitoris and the comparatively soft edges of the sealing flange 225 fit into the groove. In some cases the user can tug their outer labia to make space for the outer ring to fit snugly in the groove. The stimulators 280 can then fit snugly around the glans of the clitoris. In some instances, the user can apply an amount of a lubricant (such as a water-based lubricant) to coat their inner and outer labia, the glans of the clitoris, the hood of the clitoris, and the comparatively soft edges of the sealing flange 225. The user can activate the stimulators (in one embodiment, vibratory motors) at a relatively low power setting to help place the device. By using the sensation from the low power vibrations as a guide, the user can ensure that the clitoris is placed snugly within the space defined by the inner portions of the vibratory motors. In some cases, the user can apply stimulation with their inner labia separated. A properly placed device will be high enough on the user's vulva to effectively cup the clitoris and not block the urethra or the vaginal opening.

In certain embodiments, one or more active stimulators are carried by the device of the disclosure to stimulate the user's clitoris when the device is mounted to the user's tissue about the clitoris. The active stimulators can be of any suitable type, and can include any suitable vibrating, oscillating or other source for stimulating the user's clitoris. The stimulators of the disclosure can be embodied in one or more pulse width modulation (PWM) motors configured to communicate with the controller. In this specific regard, the PWM motor or motors are employed to generate frequencies that match specific nerve responses in the user's tissues. The controller can be programmed to operate the PWM motor or motors at frequencies that match clitoral nerve tissues. Alternatively, the user can adjust device settings to find optimal frequencies.

In an alternative approach, the stimulator can be embodied in a sonic stimulator instead of or in addition to vibratory motors. Low frequency sounds or pressures may be delivered to stimulate or match nerve characteristics of target tissue. These sounds or pressures can be pre-programmed or set by the user. In various approaches, the sonic stimulator can be a speaker or a piezo-electric resonator.

The stimulators of the disclosure include motors or other movement source that stimulates on single area or multiple areas. In one embodiment, the one or more active stimulators are embedded in the wall of a flexible suction chamber. In one embodiment, three active stimulators 280 are provided, as illustrated in FIG. 1C. In certain embodiments, the stimulators are embedded in a flexible membrane, which is attached to the walls of the suction chamber. When suction is applied, tissue is brought into contact with the stimulator. The motors can be controlled by controller circuitry to produce one or more of the following patterns: (i) all on; (ii) clockwise; (iii) counter clockwise; (iv) up-down; (v) lateral; (vi) all pulse; (vii) selected motor pulse; (viii) gradients in frequency; and (ix) gradients in amplitude. The translation of the pattern and spatial isolation of the stimulators may produce a desired effect of simulating macroscopic motion without incorporation of parts that actually move in macroscopic dimensions. Stiffening members may be added to vary and/or isolate stimulation. The inner surface of the membrane may be textured to transmit additional stimulation to tissue. The flexible membrane reduces or eliminates the coupling of the stimulation to the device housing and increases or maximizes energy delivery into the tissue.

In one embodiment, patterns are created by multiple vibratory motors. After a motor is activated it can be completely deactivated or have its power reduced such that a pattern of higher power vibration rotates around the array of motors. Rotational patterns, lateral patterns, vertical patterns, and combination thereof can be created by selectively activating and deactivating motors. All such patterns are within the scope of the disclosure disclosed herein regardless of the number of motors. Further, in embodiments herein in which vibratory motors are depicted as providing the stimulation, other stimulators can be used in place of or in addition to the vibratory motors. That is, one or more of the vibratory motors can instead be an electrical stimulator, temperature stimulator, sonic stimulator, air pressure stimulator, or other stimulator.

In certain embodiments, multiple vibratory or pressure sources create resonance or diphasic amplification. Resonant or diphasic amplification patterns may be advantageous because they may create unique stimulation patterns that would be difficult to achieve with a single source, and they may create amplification in power that exceeds the capability of a single motor or other stimulation source. Such amplification may be useful in the case of certain electrical power or space constraints. Resonance or diphasic amplification created through the use of multiple vibratory sources may employ different sources including rotary motors, linear motors, and piezoelectrics. The combination of multiple sources may create a large range of customizable and selectable resonant patterns. Further, motors of different sizes and/or power can be used to create multiple resonant frequencies to amplify the stimulation effect.

Multiple, isolated and independent stimulation sources may combine to produce diphasic amplification or resonant patterns and/or may simulate macroscopic motions. Transitions between stimulators are smoother with sine wave than square wave. Optimizing the timing and the amplitude of the motion during transition improves the “organic” feel of the stimulation. Preferably, multiple small motors or other stimulation sources are used to provide easily-differentiated stimulation and simulation of macroscopic motion. Small eccentric motors or other stimulation sources placed on edge provide a focused vibration point, which promotes differentiation among several vibration sources. Slower vibration transitions promote differentiation among several vibration sources as compared to more rapid transitions.

In certain embodiments, devices provide macroscopic motion in addition to, or instead of, simulating macroscopic motion. In certain embodiments, the controller is designed to map the user's motions on a control surface to the tissue-contacting surface of the stimulating part of the device. By pressing their fingers on the control surface, the user can create various levels of pressure or vibration in the corresponding location on the tissue-contacting surface. As the user moves their fingers across the control surface and optimally desired way, a sequence of motions, pressures, vibrations, and/or stimuli that mimic these actions are created on the tissue-contacting surface. These movements and inputs can be stored either locally on the device or a controller level and played back when desired to create desired effect without requiring the user to repeat their input pattern.

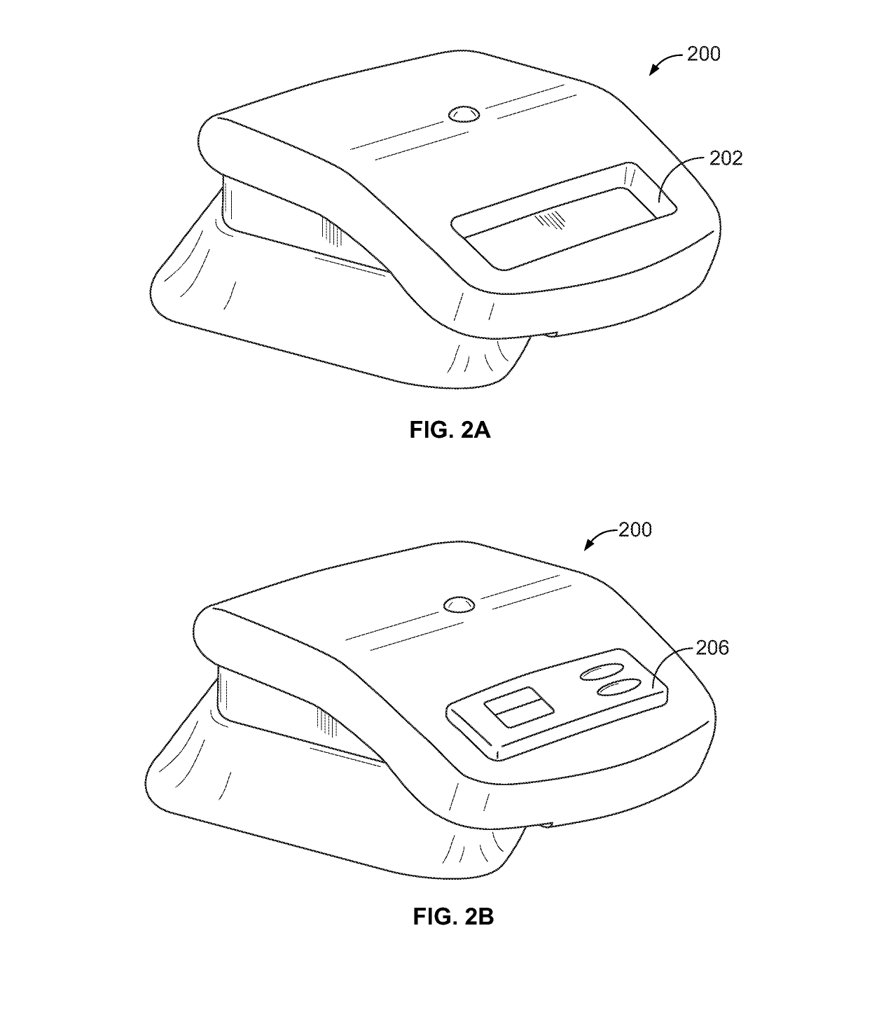

In certain embodiments, a remote controller is a controller configured to send radio-frequency signals to the device worn by the user. The controller may be sized similar to a key fob remote control commonly associated with automobiles. A remote controller can include several buttons capable of controlling the full range of functions of the device discussed herein. FIGS. 2A and 2B illustrate a remote controller 206 and device 200, which includes a complementary housing space 202 such that the remote 206 can be docked with the device and housed there when not in use or even when in use. In general, the controller circuitry can include a circuit board, amplifiers, radio antennae (including Bluetooth antennae).

Devices using low power Bluetooth or other radio antennae may experience dropped connections when the remote/device pair is separated by distance or by a physical obstruction (such as a user's or partner's body). In such cases, it is desirable for the device to remain operating under its pre-drop operating conditions while the remote attempts to automatically pair again with the device. Said differently, it is undesirable to require the user or partner to have to manually re-establish the Bluetooth pairing between the remote and the device if the pair connection is lost during device use. And, it is undesirable for the device to cease operating under its existing pre-drop conditions if a pair connection is lost. Thus, certain remotes are configured to automatically re-establish the pair connection with the device without requiring user intervention.

In situations where the remote automatically re-establishes the pair connection with the device, it can be important for the remote to query the device for the current device operating conditions. That is, since the device has maintained a state of operating conditions when the pairing was lost, it is desirable that the remote not interrupt the device operating conditions when the pair connection is re-established. As a counter example, in some Bluetooth pairings, after the pair connection is established the “master” controller will send a reset signal to the “slave” device. Such a reset would be undesirable in the circumstance where a device is operating under a given set of parameters, patterns, or programs because those parameters, patterns, or programs would be interrupted by the reset signal. Such an interruption could be detrimental to the user experience.

Some of the embodiments of the device deliver suction to engorge and stiffen the tissues and vibration to provide stimulation to the region. In other embodiments, the device delivers suction to engorge the tissues and air pressure waves to provide stimulation. In other embodiments, the device delivers suction to engorge and stiffen the tissues and electrical or neural stimulation provides stimulation to the region. In other embodiments, warming or cooling is applied, including light or infrared energy (e.g., near infrared light emitting diodes), instead of vibration or electrical or neural stimulation or air pressure waves or in combination with those stimulation types. The stimulation source preferably is in intimate contact with the tissue to optimize energy transfer.

The mounting of the stimulation sources in some embodiments allow for isolation so that there is spatial differentiation between sources and minimal diffusion of stimulation energy to adjacent structures in the device or tissue. Mounting stimulators on a flexible membrane which travels with the tissue as it becomes engorged with suction is one way to accomplish these goals. Placing holes or slits in the membrane allows for sufficient vacuum and energy transfer.

Embodiments of the device may have variable suction controlled by the user or another remote controller. A user may remotely select a pressure and the device will change to that pressure within seconds. The device may include an onboard pump that maintains suction and/or goes up/down from that initial established suction. Certain diaphragm pumps may be used as onboard pumps. Further, the motor driving the diaphragm pump may be used to produce vibratory motion. In certain embodiments, the onboard pump can be a modified voice coil designed to mimic the action of a diaphragm pump. The onboard pump can alternately be made with using a voice coil actuator that moves a membrane in a sealed and valved chamber.

In embodiments using an onboard pump or in embodiments using a remote pump, the suction may be programmed to complement the vibratory motion of the motors or the stimulation of stimulators in the device. The algorithms described herein to drive vibration are adapted to a vacuum pump system to provide fast response times and physically differentiable levels of suction to the clitoris. Further, certain embodiments use simultaneous or sequential suction waveforms or algorithms and vibration waveforms or algorithms to amplify the effect of the device.

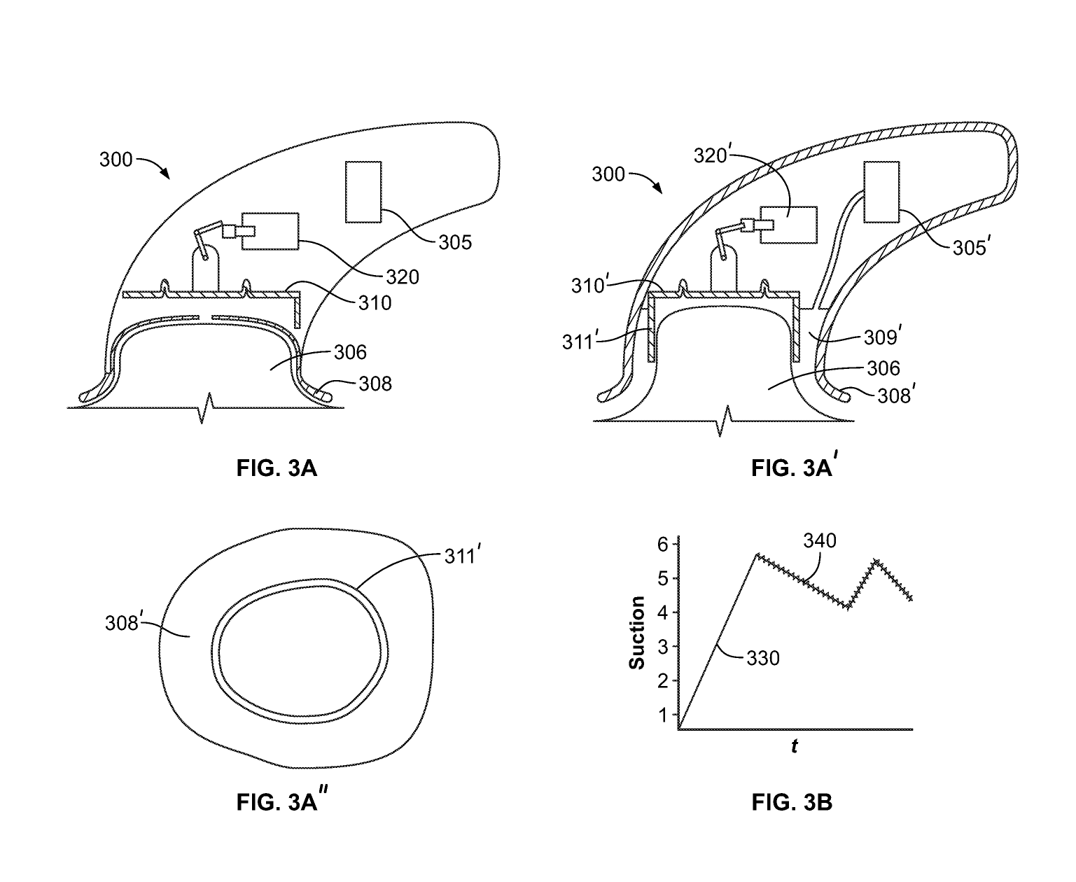

FIG. 3A depicts an alternative approach to a sexual wellness device 300 including a device body housing controller circuitry and having a clitoral tissue chamber, a pump in fluid communication with the clitoral tissue chamber, and an air pressure source configured to provide oscillating air pressure. Here, air pressure is used to generate oscillating frequency above a suction set point provided by an onboard suction pump 305 utilized as a baseline suction to establish a seal and attachment to tissue 306. Here also, the device structure defines a tether-less and wearable device for use before or during intercourse. A suction ring 308 can be employed as structure for engaging tissue, such as a clitoris. In this configuration, the vibratory motors or other stimulation sources are replaced by a bellows or membrane 310 driven by a motor or linear actuator 320. The onboard pump 305 generates a baseline suction to establish the seal and attachment. After attachment is achieved, the bellows 310 is oscillated by the motor 320 to create a secondary oscillation pressure wave. The frequency may be pre-programmed or set by the user. In this approach, part of or the entire motor membrane 310 may be driven by a motor or linear actuator 320, or actuation can be provided by a magnetic drive or voice coil, or by a buckling force that causes displacement. Accordingly, primary 330 and secondary 340 oscillation can be presented to the tissue or clitoris of the user as shown in FIG. 3B. In another embodiment shown in FIGS. 3A′-A″, the suction pump 305′ is connected to an interior space under suction chamber 308′ by suction inlet 309′ such that the air pressure wave variation is independent of the suction created by suction pump 305′. The clitoris is stimulated by bellows or membrane 310′ through tunnel 311′. The glans of the clitoris is pulled up and released in an oscillating manner in tunnel 311′.

In some embodiments of the device and method, variations in the stimulation parameters are particularly useful in providing the desired results in a user. For example, the stimulators can be varied between a high power and/or a high frequency level and a comparatively lower power and/or lower frequency setting. Without being bound to a specific mechanism or mode of action, it is believed that comparatively large variations in the power or intensity of the stimulation will produce as desirable user experience.

One of the advantages of embodiments of the disclosure with multiple stimulators and suction patterns is that different parts of the anatomy can be stimulated at different frequencies. For example, different parts of the clitoral tissue can be stimulated at different frequencies. It is generally understood that different nerve types will be stimulated to a different degree at a given frequency and that different nerves are more fully stimulated at different frequencies. One of the advantages of certain embodiments is the capability of delivering the appropriate frequency and intensity stimulation and/or suction to the different parts of the vaginal anatomy. The device can also enable the user to select and/or tune the desired frequency for their anatomy and nerve distribution, thereby customizing the user experience.

In certain embodiments, it is desirable to release suction during use. For example, the edge of the suction cup could be pulled back, squeezed, or manipulated to create a leak path. Further, a valve in line with the suction tube that can be manually manipulated by the user to release suction. In embodiments using an onboard suction pump, the pump can be configured to include a constant leak path that the pump overcomes—therefore, if the pump stops the device will automatically release. Still further, the device can be configured with a button that the user presses which opens a valve in the pump to release suction. Still further, the valve needed for the suction pump could be normally open. When power is supplied, the valve closes, completing the seal. However, if power goes out, the valve will open and the device will release automatically.

Certain embodiments of the present disclosure are designed and configured to increase blood circulation in vaginal tissue to promote engorgement to the clitoris and external genitalia while simultaneously applying stimulation to the clitoris and/or other vaginal tissue. The clitoris is a sexual organ that is filled with capillaries that supply blood to a high concentration of nerves. Certain embodiments increase blood flow to stimulate the clitoris and enhance a woman's sexual response.

In women wishing to maintain sexual wellness or be satisfied, methods and devices of certain embodiments can maintain or intensify: (i) genital sensation; (ii) arousal; (iii) vaginal lubrication; (iv) sexual satisfaction; (v) sexual desire; and/or (vi) orgasm.

Certain embodiments of the disclosure are designed and configured to be a wearable device designed to increase sexual satisfaction. Certain embodiments of the disclosure are designed and configured to be used as a “conditioning” product, to prime the user before a sexual event. Certain embodiments can be: used to help a woman prepare her body in advance of a sexual experience, typically with 5-30 minutes of use prior to sex; worn during a sexual experience with a partner, including intercourse; used by a woman alone for recreational purposes to reach orgasm; used as a regime, typically used a few minutes every day, to help facilitate a more intense and pleasurable experience during intercourse with or without a partner; or used over time to help train the body to achieve a better natural sexual response.

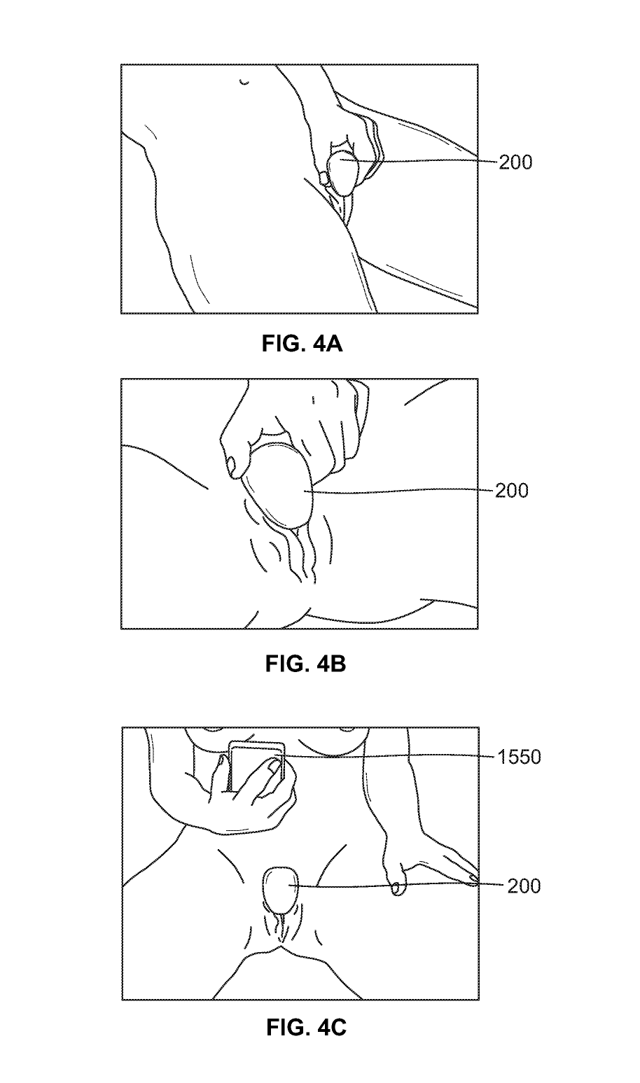

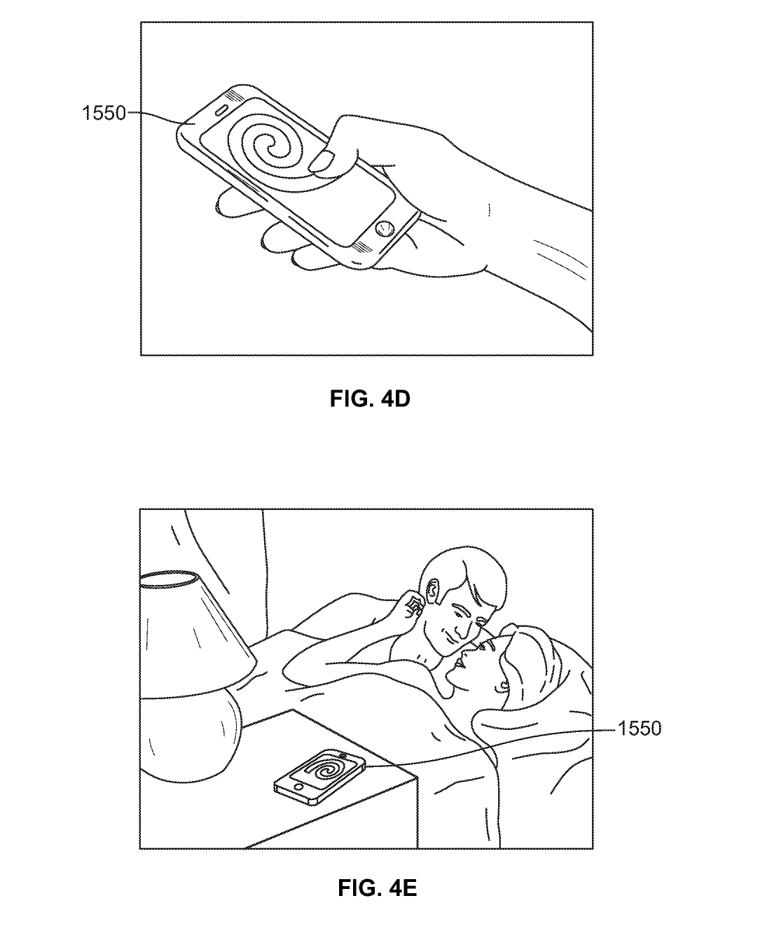

The device 200, 300 can be placed over the clitoris (FIGS. 4A-4B) by a woman or her partner. In one embodiment, gentle suction allows the product to stay in place (so it can be completely hands free once placed), although it can be quickly and easily removed as desired. A woman can sit, stand up and walk around while wearing the device 200. As shown in FIG. 4C, a small remote control 1550 or smartphone “app” is used to adjust the device's stimulation intensity and unique stroking patterns (such as the counter-clockwise movement pictured in FIGS. 4D-4E). The sequence can be customized in advance and “playlists” can be created. Once in place, the device 200 provides quiet, hands-free sexual stimulation to the clitoral region, working with a woman's body to help improve sexual response. Certain embodiments are small (about 3 inches long by about 1.5 inches wide), quiet, waterproof and discreet. The product is latex-free, hypoallergenic and washable with soap and water. It is quick and easy to place on the body, and can easily be removed. It may be worn under clothing without anyone knowing the user has it on. Since it is a hands-free product, the user can easily move around, stand or walk while wearing the device for a few minutes a day while doing something else to help a woman's body maintain a higher level of sexual responsiveness.

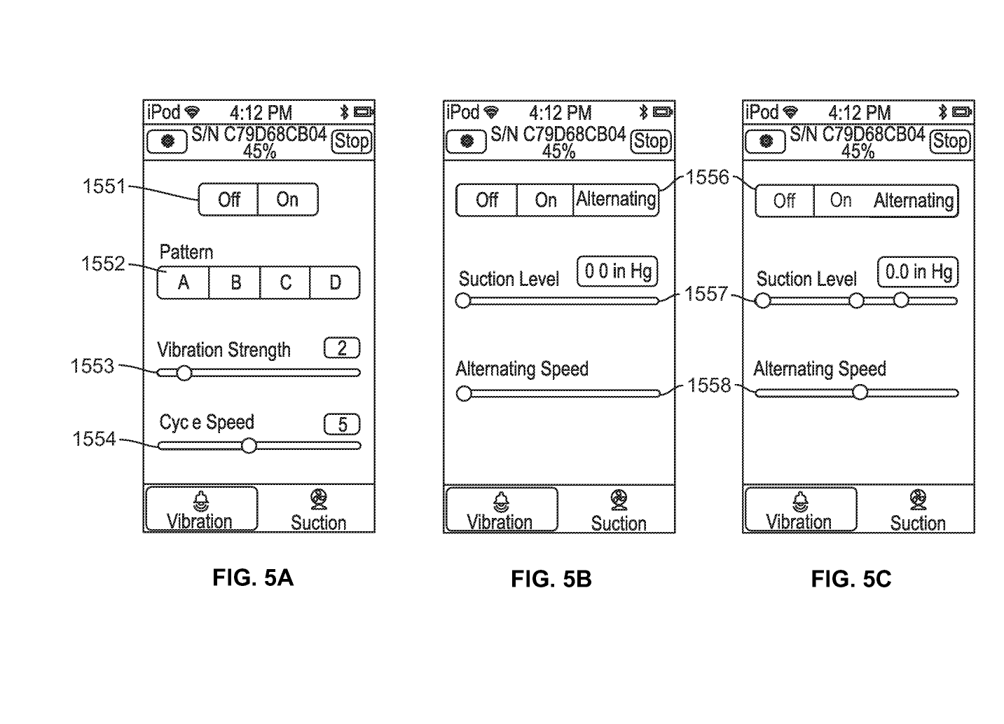

FIGS. 5A through 5C illustrate user interfaces for a smart remote controller 1550. These user interfaces provide means for controlling vibration and suction patterns, including pre-loaded patterns, user-configurable patterns, or combinations thereof. The device can include a user interface including a vibration on/off button 1551, a vibration pattern selector 1552, a vibration strength selector 1553, and a vibration cycle speed selector 1554. The vibration strength selector 1552 and vibration cycle speed selector 1554 are each shown with a numeric indicator in addition to a slider. The vibration pattern selector 1552 can be loaded with pre-loaded patterns or it can be used to store user-configurable patterns. The user interface provides an intuitive and easy-to-operate means for controlling the vibration and suction patterns of the device.

FIGS. 5B and 5C illustrate a user interface including a suction on/off button 1556, a suction level selector 1557, and a suction alternating speed selector 1558. The suction on/off button 1556 also includes an “alternating” suction setting. FIG. 5B illustrates that when the suction on/off button 1556 is in the “off” or “on” position, the suction level selector 1557 has a single slider point and the suction alternating speed selector 1558 is not available to use. When the user sets the suction on/off button 1556 to “on,” the suction level selector 1557 can be used to set a suction level on the device and that suction level can be numerically displayed in units such as “in Hg.”

FIG. 5C illustrates a user interface in which the suction on/off button 1556 has been set to “alternating.” In the “alternating” mode, the suction level selector 1557 has two slider points and the suction alternating speed selector 1558 is available. The “alternating” mode allows the user to set a primary suction level with the first slider point and a higher suction level with the second slider point. The device can then alternate between these two suction levels at a specific alternating speed that the user sets using the suction alternating speed selector 1558. Thus, the user can control both the difference in suction levels and the speed at which the device alternates between those two suction levels. Further, the user interface can contain a means for the user to store the two suction levels and the suction alternation speed. The user interface can include pre-loaded suction alternation levels and speeds, user-configurable suction alternation levels and speeds, or combinations thereof.

While the disclosure has been described with reference to certain embodiments, it will be understood by those skilled in the art that various changes may be made and equivalents may be substituted without departing from the scope of the disclosure. In addition, many modifications may be made to adapt a particular situation or material to the teachings of the disclosure without departing from its scope. Therefore, it is intended that the disclosure not be limited to the particular embodiment disclosed, but that the disclosure will include all embodiments falling within the scope of the appended claims.

1. A sexual wellness device for use by a female, comprising: a device body housing controller circuitry and having a clitoral tissue chamber; a pump in fluid communication with the clitoral tissue chamber; and an air pressure source configured to provide oscillating air pressure.

2. The sexual wellness device of claim 1, further comprising a controller that can be programmed to cause the device to provide stimulation patterns targeting specific nerve responses of target tissue.

3. The sexual wellness device of claim 1, wherein a user can adjust the device to provide stimulation patterns targeting specific nerve responses of target tissue.

4. The sexual arousal device of claim 1, wherein the stimulation source is a pulse width modulation motor.

5. The sexual wellness device of claim 1, wherein the stimulation source is sound.

6. The sexual wellness device of claim 1, wherein the stimulation source is pressure.

7. The sexual wellness device of claim 1, further comprising one or more stimulation sources that create frequencies that stimulate specific nerve responses of target tissue.

8. The sexual wellness device of claim 1, wherein oscillating frequencies are created above a suction set point.

9. The sexual wellness device of claim 1, further comprising a bellows.

10. The sexual wellness device of claim 9, wherein the pump is connected to an interior space under the clitoral tissue chamber by a suction inlet.

11. The sexual wellness device of claim 10, further comprising a motor that creates an oscillation pressure wave in the bellows.

12. The sexual wellness device of claim 1, wherein the device defines a tether-less and wearable structure for use before or during intercourse.
